(19) United States
(12) Patent Application Publication
(10) Pub. No.: US 2008/0266702 A1
(43) Pub. Date: Oct. 30, 2008

(54) SYSTEM FOR MEASURING HEAD SPACING (FLY HEIGHT) IN A DISK DRIVE

(75) Inventor: William Gene Bliss, Thornton, CO (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/963,636

(22) Filed: Dec. 21, 2007

Related U.S. Application Data
(60) Provisional application No. 60/966,543, filed on Apr. 30, 2007.

(51) Int. Cl. G11B 21/02

(52) U.S. Cl. 360/75

(57) ABSTRACT

A system and method to measure capacitance between a recording media, such as but not limited to a magnetic disk in a hard disk drive, and a read-write (RW) head is provided. Once the capacitance has been measured, the head spacing may be determined between the RW head and the recording media. This capacitance between the RW head and the recording media, is a function of geometry and the dielectric constant associated with the head spacing. Because the dielectric constant and the area of the RW head and disk are substantially constant, the only change is the separation, i.e. head spacing. Thus, the capacitance becomes a function of the head spacing or fly height.

### CROSS REFERENCE TO RELATED APPLICATIONS

The present U.S. Utility Patent Application claims priority pursuant to 35 U.S.C. §119(e) to the following U.S. Provisional Patent Applications which are hereby incorporated herein by reference in their entirety and made part of the present U.S. Utility Patent Application for all purposes:

1. U.S. Provisional Application Ser. No. 60/966,543, entitled “SYSTEM FOR MEASURING HEAD SPACING (FLY HEIGHT) IN A DISK DRIVE,” (Attorney Docket No. BP6148), filed Apr. 30, 2007, pending.

### TECHNICAL FIELD OF THE INVENTION

Embodiments of the present invention relate generally to memory storage devices; and, more particularly, embodiments of the present invention relate to measuring a head spacing between a read/write (RW) head and storage media.

### BACKGROUND OF THE INVENTION

As is known, many varieties of memory storage devices (e.g. disk drives), such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

The structure and operation of hard disk drives is generally known. Hard disk drives include, generally, a case, a hard disk having magnetically alterable properties, and a read/write mechanism including Read/Write (RW) heads operable to write data to the hard disk by locally alerting the magnetic properties of the hard disk and to read data from the hard disk by reading local magnetic properties of the hard disk. The hard disk may include multiple platters, each platter being a planar disk.

All information stored on the hard disk is recorded in tracks, which are concentric circles organized on the surface of the platters. FIG. 1 depicts a pattern of radially-spaced concentric data tracks 12 within a disk 10. Data stored on the disks may be accessed by moving RW heads radially as driven by a head actuator to the radial location of the track containing the data. To efficiently and quickly access this data, fine control of RW hard positioning is required. The track-based organization of data on the hard disk(s) allows for easy access to any part of the disk, which is why hard disk drives are called “random access” storage devices.

Since each track typically holds many thousands of bytes of data, the tracks are further divided into smaller units called sectors. This reduces the amount of space wasted by small files. Each sector holds 512 bytes of user data, plus as many as a few dozen additional bytes used for internal drive control and for error detection and correction.

With increases in data density stored to the hard disk, the air gap or RW head fly height between the RW head and the storage media has been decreasing. The RW head includes reading and/or writing electromagnetic transducer devices and/or magneto resistive devices configured to float or fly over a recording medium during recording into or reading from. In a hard disk drive, for example, a thin-film magnetic head may be mounted on a gimbal, and the gimbal is attached to a distal end of a flexible suspension arm, thereby constructing a head gimbal assembly (HGA). With increases in data density of the hard disk, the air gap or head fly height between the RW head and the storage media has been decreasing. This creates the need for more restrictive tolerances associated with this head spacing.

Prior methods to determine head spacing using indirect methods. These often require a predetermined pattern to be written and read to the disk. The measured predetermined pattern is then compared to an expected measurement. This typically requires the RW head to be proximate to the special predetermined patterns in order for the process to work. This fails to take into account any topography changes associated with the disk itself. This measurement is extremely difficult to make over data, which does not have a predefined pattern.

The predetermined pattern is typically used to calibrate changes in the head. For example, as the RW head heats up, its geometry changes. One solution to this problem has been the incorporation of resistive elements to heat the head in an attempt to maintain the head at a constant temperature or within an acceptable temperature range. This solution only allows RW head spacing measurements to be made over predetermined areas that do not even include user data.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts a prior art pattern of radially-spaced concentric data tracks within the magnetic media of a disk;

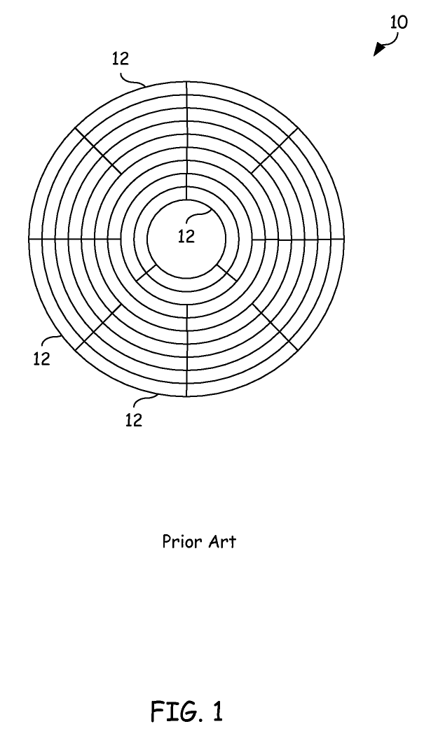

FIG. 2 depicts an embodiment of a disk drive unit in accordance with an embodiment of the present invention;

FIG. 3 illustrates an embodiment of a disk controller in accordance with an embodiment of the present invention;

FIGS. 4A through 4E depicts embodiments of various devoices that employ disk drive units in accordance with an embodiment of the present invention;

FIG. 5 depicts portions of a disk drive in accordance with embodiments of the present invention;

FIG. 6 depicts portions of a disk drive in accordance with embodiments of the present invention;

FIGS. 7A, 7B and 7C depict various exemplary circuits that may be used to determine the capacitance and head spacing in accordance with embodiments of the present invention.

FIG. 8 provides a logic flow diagram describing a method to determine head spacing in accordance with embodiments of the present invention.

FIG. 9 provides a logic flow diagram where RW head functions are adjusted (periodically or continuously) based on a head spacing in accordance with embodiments of the present invention; and

FIG. 10 provides a logic flow diagram for determining unusable areas of a recording media in accordance with the embodiments of the present invention.

### DETAILED DESCRIPTION OF THE INVENTION

Embodiments of the present invention are illustrated in the FIGS., like numerals being used to refer to like and corresponding parts of the various drawings.

Embodiments of the present invention provide a system and method to measure capacitance between a recording media, such as but not limited to a magnetic disk in a hard disk drive, and a read-write (RW) head is provided. Once the capacitance has been measured, the head spacing may be determined between the RW head and the recording media. This capacitance between the RW head and the recording media, is a function of geometry and the dielectric constant associated with the head spacing. Because the dielectric constant and the area of the RW head and disk are substantially constant, the only change is the separation, i.e. head spacing. Thus, the capacitance becomes a function of the head spacing or fly height.

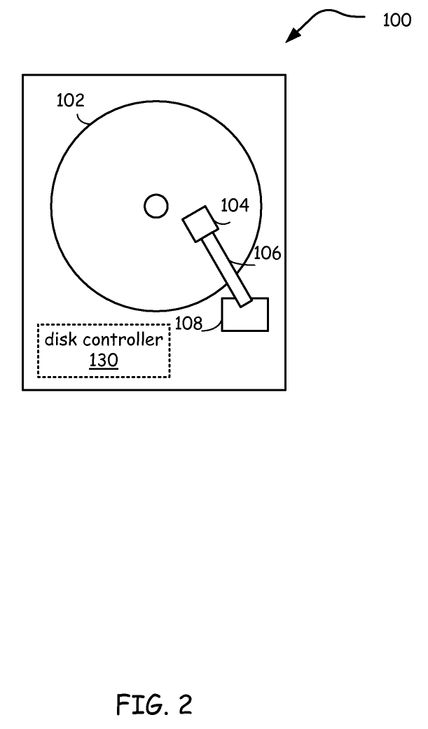

FIG. 2 illustrates an embodiment of a disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM, however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write (RW) heads 104 that are coupled to arm 106 that is moved by actuator 108 over the surface of the disk 102 either by translation, rotation or both. The head assembly may also be referred to as a head gimbal assembly (HGA) that positions a RW head, which in some embodiments may be a thin-film magnetic head, to record and read magnetic information into and from a recording surface of a hard disk or recording medium rotating at high speed. Pre-amplifier (within the RW head or located between the RW head and the disk controller) may be used to condition the signals to and from the RW head. Disk controller 130 is included for controlling the read and write operations to and from the drive, for controlling the speed of the servo motor and the motion of actuator 108, and for providing an interface to and from the host device.

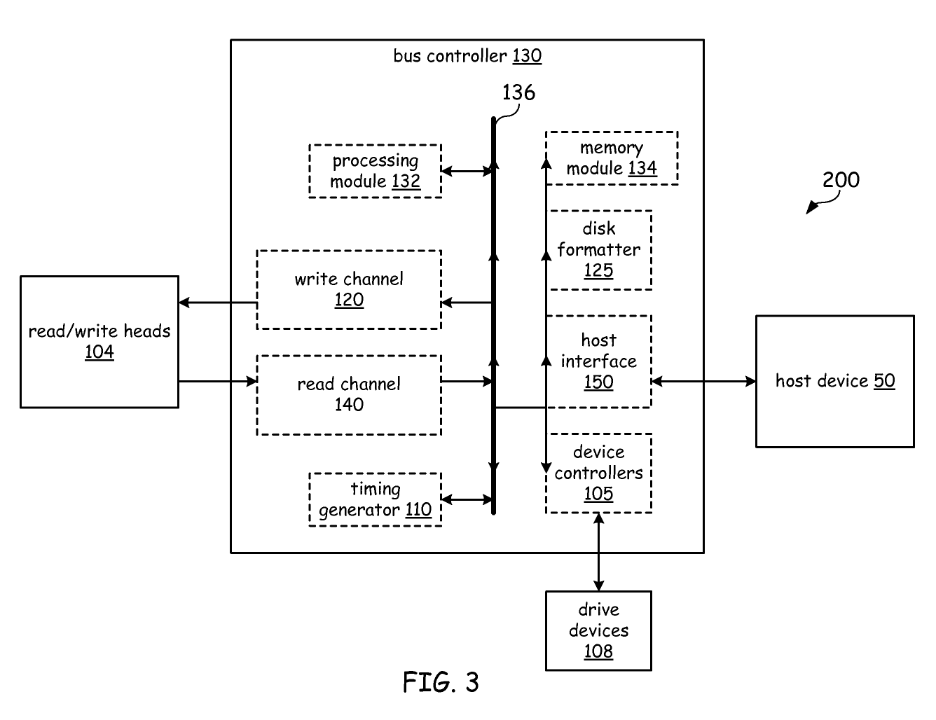

FIG. 3 illustrates an embodiment of a disk controller 130. Disk controller 130 includes a read channel 140 and write channel 120 for reading and writing data to and from disk 102 through RW heads 104. Disk formatter 125 is included for controlling the formatting of disk drive unit 100, timing generator 110 provides clock signals and other timing signals, device controllers 105 control the operation of drive devices 109 such as actuator 108 and the servo motor, etc. Host interface 150 receives read and write commands from host device 50 and transmits data read from disk 102 along with other control information in accordance with a host interface protocol. In one possible embodiment, the host interface protocol can include, SCSI, SATA, enhanced integrated drive electronics (EIDE), or any number of other host interface protocols, either open or proprietary, that can be used for this purpose.

Disk controller 130 further includes a processing module 132 and memory module 134. Processing module 132 can be implemented using one or more microprocessors, micro-controllers, digital signal processors (DSPs), microcomputers, central processing units (CPUs), field programmable gate arrays (FPGAs), programmable logic devices (PLAs), state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing timing generator 110, processing module 132, memory module 134, write channel 120, read channel 140, disk formatter 125, and host interface 150 that are interconnected via bus 136. Each of these modules can be implemented in hardware, firmware, software or a combination thereof, in accordance with the broad scope of the present invention. While the particular bus architecture is shown in FIG. 2 with a single bus 136, alternative bus architectures that include additional data buses, further connectivity, such as direct connectivity between the various modules, are likewise possible to implement additional features and functions.

In one possible embodiment, one or more modules of disk controller 130 are implemented as part of a system on a chip (SOC) integrated circuit. In such a possible embodiment, this SOC integrated circuit includes a digital portion that can include additional modules such as protocol converters, linear block code encoding and decoding modules, etc., and an analog portion that includes device controllers 105 and optionally additional modules, such as a power supply, etc. In an alternative embodiment, the various functions and features of disk controller 130 are implemented in a plurality of integrated circuit devices that communicate and combine to perform the functionality of disk controller 130.

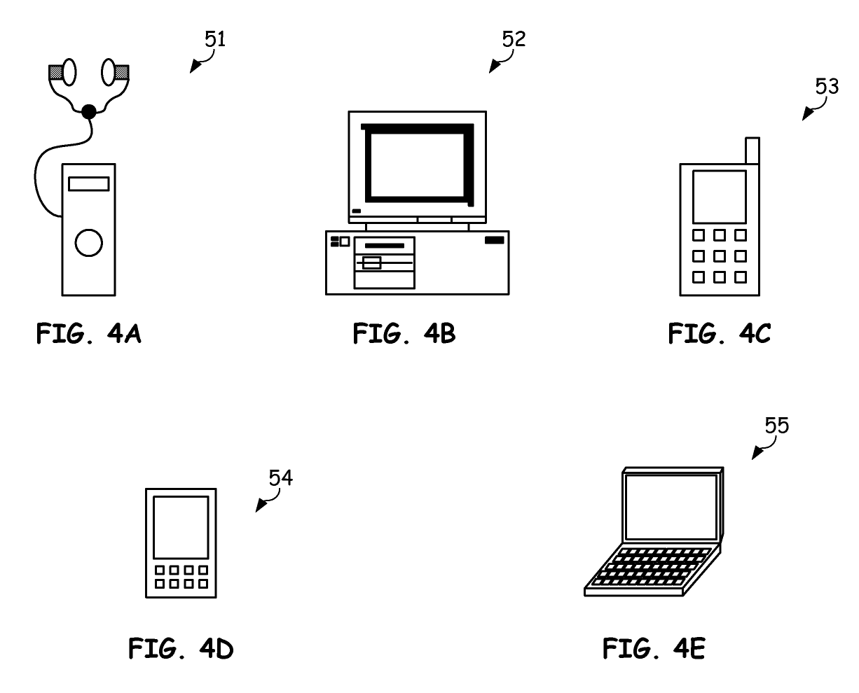

FIG. 4A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 4B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 4C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 4D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 4E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

Increases in data density stored to the hard disk, force the air gap or RW head spacing (fly height) to decrease. The RW head includes reading and/or writing electromagnetic transducer devices and/or magneto resistive devices configured to float or fly over a recording medium during recording into or reading from. The reduced dimensions create the need for more restrictive tolerances associated with this head spacing. As previously stated, prior methods to determine head spacing using indirect methods that waste disk space. Further, these solutions may calibrate the head spacing on a per zone basis to take in account non-ideal behavior of the magnetic systems.

The dedication of specific areas of the storage media for specific data patterns wherein the as read data pattern may be compared to the expected data pattern in order to determine the characteristics associated with the RW head and allow the system to compensate for the non-ideal behavior. These non-ideal behaviors are a strong function of the head spacing or fly height.

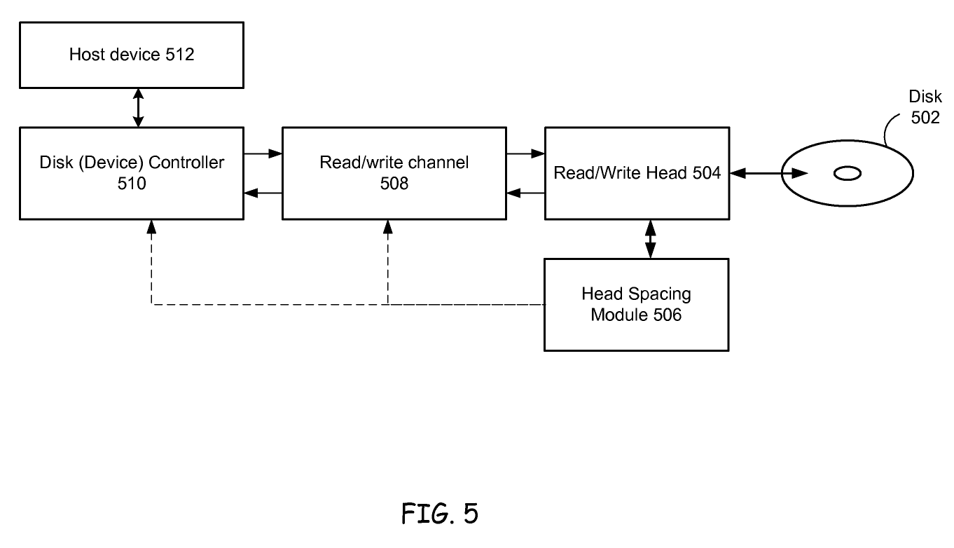

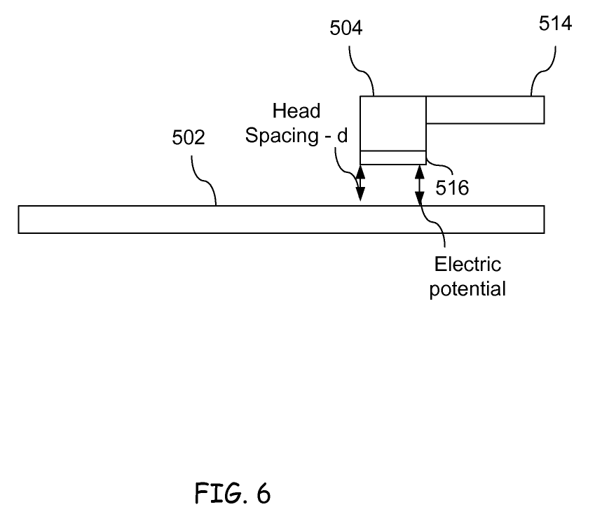

FIG. 5 depicts embodiments depicts portions of a disk drive in accordance with embodiments of the present invention. Magnetic disk drive 500 includes a magnetic disk 502, RW 504, head spacing module 506, RW channel 508, and disk controller 510. RW head 504 allows data to be written to and read from magnetic disk 502. A head spacing module 506 operably couples to RW head 504. This head spacing module will determine a head spacing between the RW head 504 and magnetic disk 502 based on a measured capacitance between RW head 504 and magnetic disk 502. As shown in FIG. 6 RW head 504 is suspended by arm 514 above disk 502. The spacing “d” between the RW head may be referred to as a head spacing or fly height. There is an electric potential between disk 502 and RW head 504. A thin film of sputtered material 516 may be used as the electromagnetic transducer devices and/or magneto resistive devices to read and write data to and from disk 502.

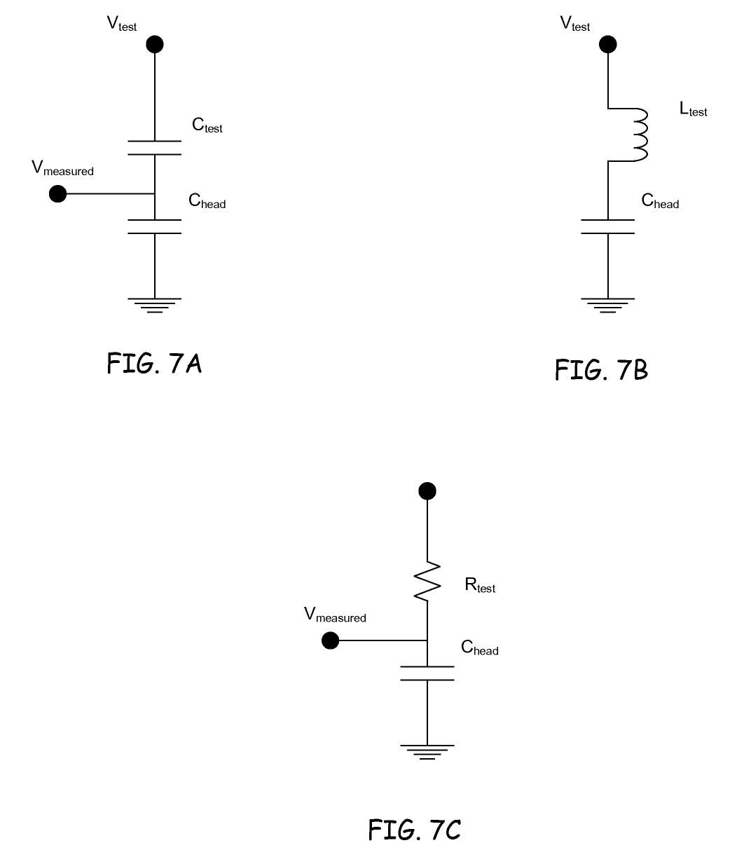

FIGS. 7A, 7B and 7C depict various exemplary circuits that may be used to determine the capacitance and head spacing in accordance with embodiments of the present invention. FIG. 7A depicts a capacitance bridge where the voltage measured across the capacitance C_{head} is a function of a supplied test voltage Vₜₑₛₜ. The capacitance of the RW head spacing may be determined by measuring the voltage V_{measured} in the capacitance network. In FIG. 7B the capacitance between the RW head and disk in this circuit may be determined from the resonance frequency of the LC circuit provided where the inductance of Lₜₑₛₜ is known. In FIG. 7C the capacitance associated with the head space gap may be determined based on the RC time constant of the circuit having a known test resistance.

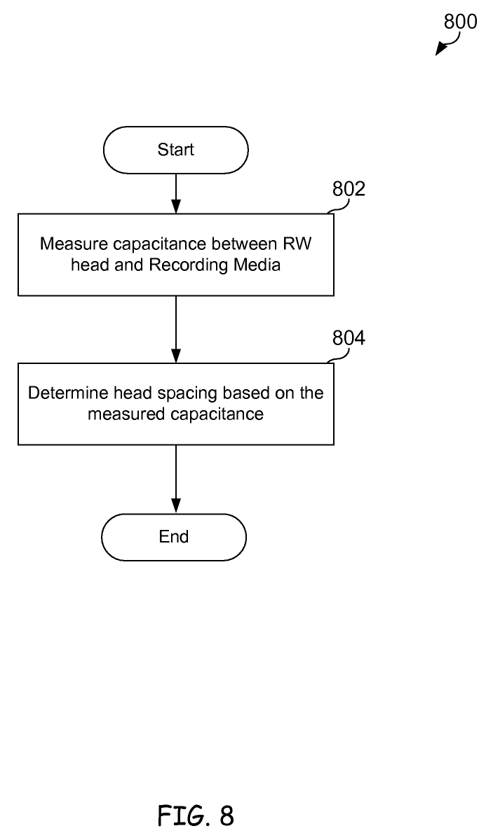

FIG. 8 provides a logic flow diagram describing a method to determine head spacing in accordance with embodiments of the present invention. The method will be used to determine the head spacing or fly height within a hard disk drive but need not be so limited. The recording media and RW head may be a disk and RW head within a hard drive but may also be applied to floppy disk drives and other like drives and devices. Operations 800 begin with step 802 wherein a capacitance between the recording media and the RW head is measured. This may be measured, for example using circuits such as, but not limited to those provided in FIG. 7A, 7B and 7C. The measured capacitance may then be used to determine a head spacing between the RW head and the recording media in step 804.

The capacitance between the RW head and recording media may be modeled as parallel plate capacitors wherein the capacitance is a function of the potential difference between the RW head and disk. Within parallel plate capacitors wherein the ratio of charged to voltage (i.e. capacitance) is a function only of geometry. In this case the area of the RW head and disk, and dielectric constant remain constant and their separation (i.e. head spacing) changes. Thus the measured capacitance is a function of the inverse of the fly height or head spacing.

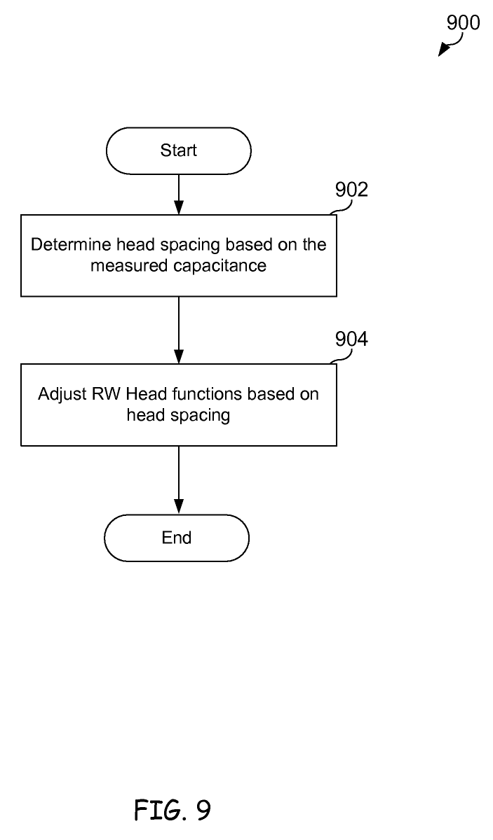

FIG. 9 provides a logic flow diagram in accordance with embodiments of the present invention where RW head functions are adjusted (periodically or continuously) based on a head spacing in accordance with embodiments of the present invention. Operations 900 begin in step 902 where head spacing between the RW head and the recording media is determined by measuring the capacitance between the recording media and the RW head. This allows in step 904 the adjustment of RW head functions based on knowing the RW head spacing. For example, step 904 may involve adjusting of a write current or write pre-comp value as a function of head spacing. Alternatively, during a read operation an equalization (FIR) and/or data dependent noise prediction (DDNP) noise parameter may be adjusted based on head spacing. In another embodiment the actual head spacing itself may be adjusted based on the measured capacitance in order to maintain a constant or substantially constant head spacing. Continuously determining the head spacing also allows one to potentially abort a write operation to the recording media based on a discontinuity in the head spacing. If such a case where allowed to continue, the data intended to be written would be forever lost. By continuously determining the head spacing and identifying a discontinuity in the head spacing the write may be aborted such that that data may be written elsewhere to the recording media.

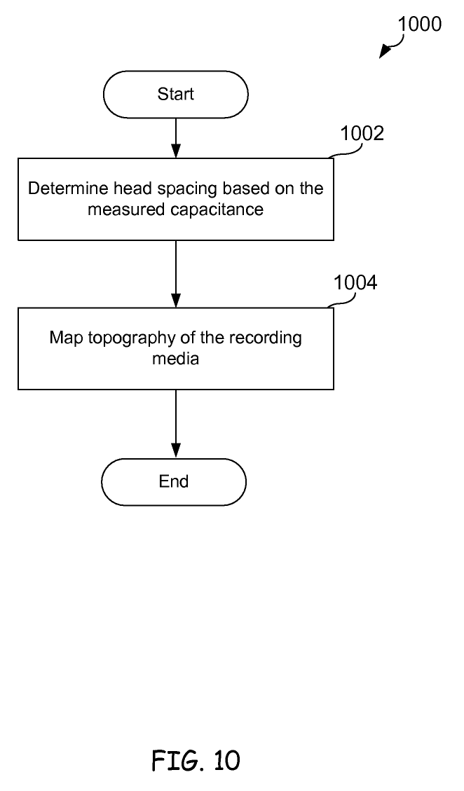

FIG. 10 provides a logic flow diagram for determining unusable areas of a recording media in accordance with the embodiments of the present invention. In step 1002 head spacing between the RW head and the recording media may be determined based on capacitance. In step 1004 the topography of the recording media may be mapped wherein discontinuities beyond the capability of the RW head positioning system may be identified. These may be identified as unusable areas by the disk drive controller in the case of a hard disk drive. This may be done in a hard disk drive, floppy disk drive, tape drive, or any other device where a capacitance exists between the RW head and the recording media.

Embodiments of the present invention provide a system and method to measure capacitance between a recording media, such as but not limited to a magnetic disk in a hard disk drive, and a RW head. Once the capacitance has been measured, the head spacing may be determined between the RW head and the recording media. This capacitance between the RW head and the recording media, is a function of geometry and the dielectric constant associated with the head spacing. Because the dielectric constant and the area of the RW head and disk are substantially constant, the only change is the separation, i.e. head spacing. Thus, the capacitance becomes a function of the head spacing or fly height.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions, and alterations can be made hereto without departing from the spirit and scope of the invention as described by the appended claims.

What is claimed is:

1. A method to determine head spacing comprising;
measuring a capacitance between a recording media and read write (RW) head; and
determining the head spacing between the RW head and the recording media based on the measured capacitance.

2. The method of claim 1, further comprising adjusting a write current or write recoup value as a function of the head spacing.

3. The method of claim 1, further comprising:
adjusting the head spacing based on the determined head spacing to maintain substantially constant head spacing.

4. The method of claim 1, further comprising adjusting an equalization (FIR) and/or DDNP noise parameter during a read.

5. The method of claim 1, wherein the measured capacitance is a function of the head spacing.

6. The method of claim 1, further comprising:
mapping a topography of the recording media based on the head spacing; and
determining unusable areas of the recording media based on the topography.

7. The method of claim 1, further comprising:
continuously determining the head spacing; and
aborting a write to the recording media based on a change in head spacing.

8. A magnetic disk drive comprising:
a magnetic disk operable to store data therein;
a read/write (RW) head, the RW head operable to RW data to the magnetic disk;
a head spacing module operable to determine a head spacing between the RW head and the magnetic disk based on a measured capacitance between the RW head and the magnetic disk;
a RW channel, operably coupled to the RW head, that reads/writes data to the from the disk drive; and
a device controller operably coupled to the RW head and the head spacing module, the device controller adjusts the operation of the RW head based on the head spacing.

9. The magnetic disk drive of claim 8, wherein the head spacing module continuously determines the head spacing.

10. The magnetic disk drive of claim 8, wherein the head spacing module measures capacitance between the RW head and the magnetic disk using at least one circuit selected from the group consisting of:
a capacitance bridge;
an inductor—capacitor (LC) circuit; and
a resistor—capacitor (RC) circuit.

11. The magnetic disk drive of claim 8, wherein a write current or write recoup value within the RW head is adjueted as a function of the head spacing.

12. The magnetic disk drive of claim 8, wherein the device controller adjusts the head spacing based on the determined head spacing to maintain substantially constant head spacing.

13. The magnetic disk drive of claim 8, wherein the RW head adjusts an equalization (FIR) and/or data dependant noise prediction (DDNP) noise parameter during a read operation based on the determined head spacing.

14. The magnetic disk drive of claim 8, wherein a disk controlller is operable to:
map a topography of the magnetic disk based on the head spacing; and
identify unusable areas of the recording media based on the topography.

15. The magnetic disk drive of claim 8, wherein the magnetic disk drive is operable to abort a write operation based on a change in head spacing.

16. A system operable to read/write (RW) data to a storage media comprising:
a read/write (RW) head, the RW head operable to RW data to the storage media;
a head spacing module operable to determine a head spacing between the RW head and the storage media based on a measured capacitance between the RW head and the storage media;
a RW channel, operably coupled to the RW head, that reads/writes data to the from the RW head; and
a device controller operably coupled to the RW head and the head spacing module, the device controller adjusts the operation of the RW head based on the head spacing.

17. The system of claim 16, wherein the head spacing module continuously determines the head spacing.

18. The system of claim 16, wherein the head spacing module measures capacitance between the RW head and the magnetic disk using at least one circuit selected from the group consisting of:
a capacitance bridge;
an inductor—capacitor (LC) circuit; and
a resistor—capacitor (RC) circuit.

19. The system of claim 16, wherein a write current or write recoup value within the RW head is adjueted as a function of the head spacing.

20. The system of claim 16, wherein the device controller adjusts the head spacing based on the determined head spacing to maintain substantially constant head spacing.

21. The system of claim 16, wherein the RW head adjusts an equalization (FIR) and/or data dependant noise prediction (DDNP) noise parameter during a read operation based on the determined head spacing.

22. The system of claim 16, wherein a disk controlller is operable to:
map a topography of the magnetic disk based on the head spacing; and
identify unusable areas of the recording media based on the topography.

23. The system of claim 16, wherein the magnetic disk drive is operable to abort a write operation based on a change in head spacing.

24. A preamplifier operable to adjust the operation of the read/write (RW) head based on the head spacing comprising:
a head spacing module operable to determine a head spacing between the RW head and the storage media based on a measured capacitance between the RW head and the storage media;
a processing module operably coupled to the RW head and the head spacing module, the device controller adjusts the operation of the RW head based on the head spacing.
